(19) United States
(12) Patent Application Publication
(10) Pub. No.: US 2023/0010138 A1
(43) Pub. Date: Jan. 12, 2023

(54) Universal One-Step Method to Make Fe-Based (Oxy)Hydroxides as Efficient OER Catalysts for Seawater Electrolysis

(71) Applicant: University of Houston System, Houston, TX (US)

(72) Inventors: Zhifeng REN, Pearland, TX (US); Luo YU, Houston, TX (US); Minghui NING, Houston, TX (US)

(73) Assignee: University of Houston System, Houston, TX (US)

(21) Appl. No.: 17/832,414

(22) Filed: Jun. 3, 2022

Related U.S. Application Data
(60) Provisional application No. 63/219,788, filed on Jul. 8, 2021.

(51) Int. Cl. C25B 1/04; C25B 11/061; C25B 11/077; C25B 15/02

(52) U.S. Cl. CPC C25B 1/04; C25B 11/061; C25B 11/077; C25B 15/02

(57) ABSTRACT

A method for ambient-temperature synthesis of a catalyst for water electrolysis by dissolving an amount of an Fe²⁺ source and optionally an amount of a salt of another divalent cation in deionized water at ambient temperature to form a solution, placing nickel (Ni) foam into the solution, whereby the Ni foam serves as a substrate and/or a Ni source for growth of the catalyst, leaving the Ni foam in the solution at ambient temperature for a time duration in a range of from about 0.5 hour to about 4 hours to provide a treated foam, during which time duration, the catalyst is grown on the substrate, and removing the treated foam from the solution after the time duration, wherein the treated foam comprises the catalyst grown thereon.

### CROSS-REFERENCE TO RELATED APPLICATIONS

This application claims benefit of U.S. provisional patent application Serial No. 63/219,788 filed Jul. 8, 2021, and entitled “Universal One-Step Method to Make Fe-Based (Oxy)Hydroxides as Efficient OER Catalysts for Seawater Electrolysis,” which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The present disclosure relates generally to electrolysis of water. More specifically, the present disclosure relates to fast ambient-temperature synthesis of catalysts for water electrolysis.

### BACKGROUND

Water electrolysis is a sustainable and clean route to produce hydrogen (H₂) fuel, which is an important component of renewable-energy. Principally, water electrolysis includes two half-reactions: the hydrogen evolution reaction (HER) on the cathode and the oxygen evolution reaction (OER) on the anode. Compared with the HER process, OER is more sluggish because of the rigid O-O double bond and the multistep proton and electron transfer process, which hampers the overall efficiency of water electrolysis. There has been progress in developing efficient OER catalysts in order to decrease the OER overpotentials, including developing efficient OER catalysts that prevail over the benchmark of iridium and ruthenium dioxides (IrO₂ and RuO₂), which largely expedites the uphill water electrolysis process.

While there has been interest in developing efficient catalysts, little attention has been paid to energy and time costs of synthesizing the catalysts. For example, MoNi₄/MoO₂ is the most active HER catalyst reported and requires overpotentials of only 15 and ~70 mV at current densities of 10 and 500 mAcm⁻², respectively. However, synthesizing this catalyst entails a multistep procedure that is conducted over a long period of time at high temperatures and that even requires the consumption of high-purity H₂ gas, which is not economic for large-scale applications. The issue of high synthesis costs also applies to synthesis of many reported OER catalysts, which typically involves tedious multistep procedures under high temperatures and require significant time and energy consumption. Accordingly, the present disclosure considers OER catalyst efficiency as well as synthesis costs.

### SUMMARY OF THE DISCLOSURE

Embodiments of the present disclosure are described in detail with reference to the drawings wherein like reference numerals identify similar or identical elements.

The present disclosure relates to fast ambient-temperature synthesis of OER catalysts for water electrolysis.

In aspects of the present disclosure, a method for ambient-temperature synthesis of catalysts for water electrolysis includes: dissolving an amount of an Fe²⁺ source and optionally an amount of a salt of another divalent cation in deionized water at ambient temperature to form a solution; placing Ni foam into the solution, the Ni foam serving as a substrate and/or a Ni source for growth of the catalyst; leaving the Ni foam in the solution at ambient temperature for a time duration (e.g., in a range of from about 0.5 hour to about 4 hours) to provide a treated foam, during which time duration, the catalyst is grown on the substrate; and removing the treated foam from the solution after the time duration, wherein the treated foam comprises the catalyst grown thereon.

Also provided herein is a catalyst for water electrolysis produced via the herein described method for ambient-temperature synthesis of catalysts for water electrolysis.

Also provided herein is a water electrolyzer that includes: an anode formed by a an electrode comprising the catalyst produced via the herein described method for ambient-temperature synthesis of catalysts for water electrolysis; and a cathode.

Also described herein is a method for ambient-temperature synthesis of a catalyst for water electrolysis, the method comprising: dissolving an amount of FeSO₄•7H₂O and an amount of Ni(NO₃)₂ • 6H₂O in deionized water at ambient temperature to form a solution; placing nickel (Ni) foam into the solution, the Ni foam serving as a substrate and/or a Ni source for growth of NiFe layered double hydroxide (NiFe LDH) catalyst; leaving the Ni foam in the solution at ambient temperature for a time duration (e.g., in a range of from about 0.5 hour to about 4 hours) to provide a treated foam, during which time duration the NiFe LDH catalyst is grown on the substrate; and removing the treated foam from the solution after the time duration, wherein the treated foam comprises the NiFe LDH catalyst.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is a schematic perspective view of an exemplary two-electrode electrolyzer for alkaline seawater electrolysis, in accordance with aspects of the present disclosure;

FIG. 2 is a flow diagram of an exemplary method for ambient-temperature synthesis of a catalyst for water electrolysis, in accordance with aspects of the present disclosure;

FIG. 3 is a schematic illustration of, and explanation of the underlying mechanism for, the spontaneous growth of NiFe LDH at room temperature;

FIG. 4 is a photograph of NF/NiFe LDH samples prepared with different amounts of immersion time, as described in the Example.

FIG. 5 is an enlarged view of the three-dimensional (3D) porous framework of the NF substrate of the Example;

FIGS. 6a and 6b depict SEM images of pure NF at different magnifications, as described in the Example;

FIGS. 6c and 6d depict SEM images of NF/NiFe LDH at different magnifications, as described in the Example;

FIGS. 6e and 6f depict TEM images of NiFe LDH at different magnifications, as described in the Example;

FIG. 6g depicts the SAED pattern of NiFe LDH, as described in the Example;

FIG. 6h depicts the high-resolution TEM image (HRTEM) of NiFe LDH of the Example;

FIG. 6i depicts the TEM image of NiFe LDH for EDX mapping, as described in the Example;

FIGS. 6j-6m provide overview elemental mapping of the Example;

FIG. 7 depicts SEM images of NF/NiFe LDH samples prepared with different amounts of immersion time: 7a and 7b, 1 h; 7c and 7d, 3 h; 7e and 7f, 4 h, as described in the Example.

FIG. 8 depicts the map sum spectrum of EDX mapping of the Example;

FIG. 9 depicts the XPS survey spectrum of the NF/NiFe LDH of the Example;

FIGS. 10a-10c depict the high-resolution XPS spectra of the NF/NiFe LDH of the Example, where FIG. 10a depicts Ni 2p, FIG. 10b depicts Fe 2p, and FIG. 10c depicts O 1s;

FIG. 10d depicts the Raman measurement of the NF/NiFe LDH of the Example;

FIG. 11 depicts the OER performance (LSV curves) of NF/NiFe LDH samples prepared with different amounts of immersion time, as described in the Example;

FIG. 12 depicts the OER performance (LSV curves) of different samples prepared in the Example using the herein disclosed Fe²⁺-driven fabrication method;

FIG. 13a shows the OER performance (LSV curves) for different electrodes in 1 M KOH, as described in the Example;

FIG. 13b depicts the overpotentials to achieve different current densities for different electrodes in 1 M KOH, as described in the Example;

FIG. 13c depicts the Tafel slopes for different electrodes in 1 M KOH, as described in the Example;

FIG. 13d depicts EIS for different electrodes in 1 M KOH, as described in the Example;

FIG. 13e depicts the OER performance (LSV curves) of the NF/NiFe LDH of the Example in different electrolytes;

FIG. 13f depicts the overpotentials to achieve different current densities for the NF/NiFe LDH of the Example in different electrolytes;

FIG. 13g depicts long-term OER stability tests of the NF/NiFe LDH of the Example at different current densities in different electrolytes;

FIG. 14 depicts the OER performance (LSV curves) of the NF/NiFe LDH of the Example with and without iR compensation;

FIGS. 15A-15B provide Table 1, which tabulates an OER activity and synthesis method comparison between the NF/NiFe LDH catalyst of this disclosure and other state-of-the-art OER catalysts in 1 M KOH electrolyte;

FIG. 16 depicts the OER performances (LSV curves) of the NF/NiFe LDH fabricated by three methods including the method 200 of this disclosure, conventional electrodeposition method (ED), and conventional hydrothermal method (HT), as described in the Example;

FIG. 17 shows an equivalent circuit 300 for the EIS Nyquist plots, as described in the Example;

FIG. 18a and FIG. 18b depict the SEM images after the stability test of the Example;

FIG. 18c and FIG. 18d depict the TEM images after the stability test of the Example;

FIG. 18e and FIG. 18f depict the Ni 2p and Fe 2p XPS spectra, respectively, before and after the stability test of the Example;

FIG. 19a depicts HER performance and (inset) Tafel slope of NF/NiMoN in 1 M KOH;

FIG. 19b depicts the overall seawater splitting performance of NF/NiFe LDH∥NF/NiMoN in different electrolytes;

FIG. 19c depicts the voltages to drive different current densities by NF/NiFe LDH∥NF/NiMoN in different electrolytes;

FIG. 19d depicts the voltages for different water electrolyzers to reach a current density of 10 mA/cm² in 1 M KOH;

FIG. 19e depicts the Faradaic efficiency measurement;

FIG. 19f depicts the long-term overall seawater splitting test of NF/NiFe LDH∥NF/NiMoN in alkaline natural seawater; and

FIG. 20 depicts the overall water splitting performance of the NF/NiFe LDH∥NF/NiMoN water electrolyzer 100 of this disclosure with and without iR compensation in 1 M KOH, as described in the Example.

Further details and aspects of various embodiments of the present disclosure are described in more detail below with reference to the appended figures.

### DETAILED DESCRIPTION OF DISCLOSED EXEMPLARY EMBODIMENTS

Although the present disclosure will be described in terms of specific embodiments, it will be readily apparent to those skilled in this art that various modifications, rearrangements, and substitutions may be made without departing from the spirit of the present disclosure.

For purposes of promoting an understanding of the principles of the present disclosure, reference will be made to exemplary embodiments illustrated in the drawings, and specific language will be used to describe the same. It will nevertheless be understood that no limitation of the scope of the present disclosure is thereby intended. Any alterations and further modifications of the features illustrated herein, and any additional applications of the principles of the present disclosure as illustrated herein, which would occur to one skilled in the relevant art and having possession of this disclosure, are to be considered within the scope of the present disclosure.

The present disclosure relates to fast ambient-temperature synthesis of OER catalysts for water electrolysis. Aspects of the present disclosure relate to a fast, cost-effective, and scalable method to synthesize Fe-based (oxy)hydroxide catalysts at ambient temperature for high performance seawater electrolysis. Although aspects of the present disclosure will be described below with respect to seawater electrolysis, the aspects and embodiments described herein are applicable to fresh water and to water from sources other than natural seawater. All such applications of water electrolysis are contemplated to be within the scope of the present disclosure.

Hydrogen has been considered a promising energy resource to replace fossil fuel because of its high burning heat, low mass density, and, most importantly, carbon-free emissions. Water electrolysis is a sustainable way to produce hydrogen, but thus far most studies of water electrolysis have focused on fresh water, which is a scarce resource, especially in many arid zones. Thus, seawater splitting is a more practical method for hydrogen production given the enormous amount of seawater. In addition, seawater electrolysis can not only generate clean energy, but also boosts the seawater desalination process because the product of hydrogen consumption is high-purity water. That is, consuming energy from seawater electrolysis will help to generate fresh water and alleviate its scarcity.

However, seawater electrolysis is much more challenging than fresh water electrolysis due to the following: i) the presence of Cl⁻ ions in seawater will lead to the chlorine evolution reaction (CER), which is competitive with the oxygen evolution reaction (OER); ii) some impurity ions such as Mg²⁺and Ca²⁺ will generate insoluble precipitates under alkaline conditions, and thus block the active sites of OER and hydrogen evolution reaction (HER) catalysts; iii) the unavoidable poisoning effect by the complex organic and inorganic impurities in seawater. In order to address these challenges, great effort has been made to understand the underlying mechanism of seawater electrolysis, and some solutions corresponding to these challenges are: i) early studies showed that OER is more thermodynamically but less kinetically favorable than CER. With a pH value higher than 7, the chemical potential between OER and CER (hypochlorite formation reaction in alkaline conditions) will be maximized, with an oxidation potential difference of about 480 mV. That is to say, if an OER catalyst can generate meaningful current densities requiring overpotentials of less than 480 mV, the CER process will be thermodynamically suppressed. ii) The majority of insoluble precipitates can be removed by a simple filtration or centrifugation pretreatment prior to electrolysis. iii) While the poisoning effect by impurities is unavoidable in most situations, it is highly variable for different catalysts. Thus, researchers can seek out impurity-resistant catalysts in order to minimize the poisoning effect.

NiFe layered double hydroxide (LDH) has been proved to be an efficient and stable OER catalyst under alkaline seawater conditions. Currently, the most common methods to fabricate NiFe LDH are electrodeposition and hydrothermal techniques, which require either enormous energy input or elaborate equipment, and thus would introduce a financial burden to large-scale industrial application. Therefore, developing a rapid, facile, and low-energy-consumption method to fabricate NiFe LDH is of great significance for industrial application. An ultrafast room-temperature synthesis of highly active S-doped Ni/Fe (oxy)hydroxides based on the corrosion of nickel foam via Fe³⁺ and accelerated by the additive Na₂S₂O₃ has previously been described, which is different from this work. Herein provided is a one-step room-temperature spontaneous deposition of NiFe LDH nanosheets based on the oxidation of Fe²⁺ ions, which is a process that many electrodeposition researches tried to avoid. However, in this research, the oxidation of Fe²⁺ ions is utilized to generate highly active OER catalysts (e.g., NiFe LDH, CoFe LDH, FeOOH, etc.) through a very facile method. Commercial nickel foam (NF) is utilized as the substrate and is immersed in an Fe²⁺ aqueous solution (e.g., an Fe²⁺ aqueous solution, an Ni²⁺/Fe²⁺ aqueous solution, a Co²⁺/Fe²⁺ aqueous solution, or another Fe²⁺ aqueous solution comprising Fe²⁺ and S²⁺, wherein S is a divalent cation of another salt) for several hours (e.g., 1 hour to 5 hours). A uniform layer of the catalyst (e.g., NiFe LDH nanosheets, CoFe LDH nanosheets, FeOOH (oxy)hydroxide, etc.) is thus grown on the nickel foam surface. An electrode (e.g., an NF/NiFe LDH electrode, a NF/CoFe LDH electrode, an NF/FeOOH electrode, etc.) fabricated by this method and utilized as an electrode of a water electrolyzer exhibits very good OER activity and good stability under different seawater electrolytes. The electrode of this disclosure (e.g., the NF/NiFe LDH electrode, a NF/CoFe LDH electrode, an NF/FeOOH electrode, etc.) can be coupled with a state-of-art HER catalyst, such as, without limitation, NiMo nitride (NiMoN), to fabricate an outstanding seawater electrolyzer that delivers efficient and robust performance in alkaline seawater solutions.

Generally, efficient catalysts for water electrolysis include transition-metal oxides, (oxy)hydroxides, selenides, phosphides, and nitrides. Among these catalysts, the transition-metal (oxy)hydroxides, and especially the NiFe-based (oxy)hydroxides, are the most efficient oxygen evolution reaction (OER) catalysts, and they are the catalytically active species generated from surface reconstruction on many types of oxygen-evolving materials.

There are various strategies to promote the OER activity of NiFe-based (oxy)hydroxide catalysts, including morphology design to expose more active sites, surface defect engineering to regulate the electronic structure, and integration with carbon materials to improve electron transfer. For example, NiFe (oxy)hydroxides derived from NiFe disulfides can be coupled with carbon nanotubes for efficient OER in alkaline media. This catalyst requires an overpotential of 190 mV at a current density of 10 mA cm⁻² and is one of the OER catalysts that reduce the overpotential needed for the current density of 10 mA cm⁻² to below 200 mV. As another example, a core-shell catalyst of NiFe alloy (core) and ultrathin amorphous NiFe oxyhydroxide (shell) nanowire arrays, exhibits OER activity with overpotentials of 248 and 258 mV required to achieve large current densities of 500 and 1000 mA cm⁻², respectively, and meets industrial criteria of large current densities ≥ 500 mA cm⁻² at overpotentials ≤ 300 mV. As persons skilled in the art will recognize, higher current density corresponds to higher hydrogen production rate. Therefore, such examples of efficient catalysts can significantly advance the development of water electrolysis for large-scale hydrogen production, if lower time and energy costs of synthesizing the catalysts can be implemented.

An abundant supply of water for electrolysis is seawater. Compared with splitting purified water, seawater electrolysis is an effort that has greater benefits because it can be used for both hydrogen generation and seawater desalination. However, seawater electrolysis is dependent on highly active and robust OER catalysts that can sustain seawater splitting without chloride corrosion and that can do so over a large range of salinity. As reactions occur, the salt concentration in the water increases and, therefore, the catalyst should have sufficient catalytic activity across a range of salinity.

As explained in more detail below, the present disclosure relates to Fe-based (oxy)hydroxide catalysts for high-performance seawater electrolysis and provides cost-effective and facile methodologies to synthesize such catalysts at ambient temperatures. In summary, a one-step synthesis method is disclosed to fabricate self-supported Fe-based (oxy)hydroxide catalysts (e.g., NiFe layered double hydroxide (denoted herein as NiFe LDH) catalysts, CoFe LDH catalysts, FeOOH catalysts, or the like) from readily available Ni foam in less than or equal to about 2 hours at ambient temperature. This fast synthesis method operates to engineer the surface of Ni foam into a hydrophilic NiFe LDH, CoFe LDH, FeOOH, or the like. The catalyst can exhibit multiple levels of porosity with a large surface area and numerous active sites. Unlike prior electrodeposition or hydrothermal methods that result in weak contact between the catalyst and the substrate, the Ni foam in the disclosed synthesis method is directly reacted with a solution to produce the catalyst (e.g., NiFe LDH, CoFe LDH, FeOOH, or the like) which produces highly robust contact and strong bonds and contributes to rapid electron transfer and good stability.

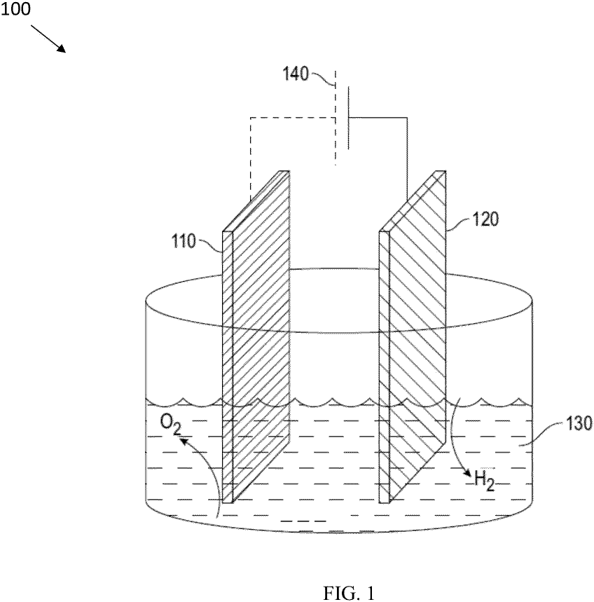

FIG. 1 shows an exemplary two-electrode electrolyzer for alkaline seawater electrolysis. In the illustrated configuration, a catalyst of this disclosure (e.g., NiFe LDH catalyst, CoFe LDH catalyst, FeOOH catalyst, or the like) is directly used as an OER electrode 110. This OER electrode is paired with a HER electrode 120, in electrolyte 130. The HER catalyst can be any suitable HER catalyst. In embodiments, the HER catalyst comprises a HER catalyst of NiMoN, as described hereinbelow. In aspects, the electrolyte comprises 1 M KOH plus seawater, and the two-electrode electrolyzer can achieve current densities of 10, 100, and 500 mA cm-2 at voltages 140 of 1.477 V, 1.533, and 1.665 V, respectively, and exhibit very good durability.

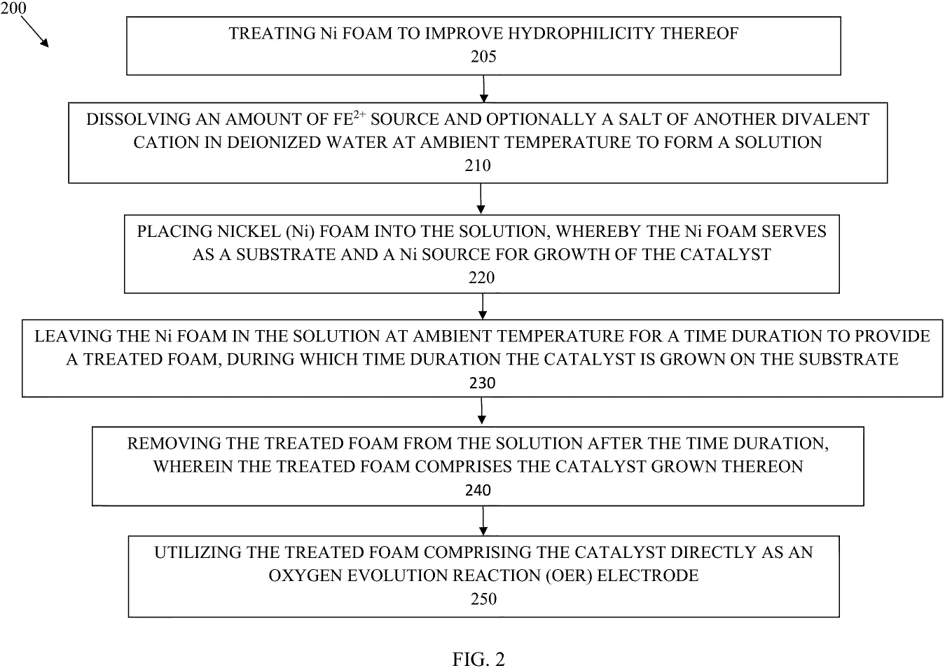

FIG. 2 shows a flow diagram of an exemplary method 200 for synthesizing the catalyst of this disclosure at ambient temperature. Method 200 includes, at 210, dissolving an amount of an Fe²⁺ source and optionally an amount of a salt of another divalent cation in deionized water (e.g., in a receptacle or container, such as, without limitation, a glass bottle or beaker) at ambient temperature to form a solution. Method 200 further comprises, at 220, placing nickel (Ni) foam into the solution. The Ni foam can serve as a substrate and/or a Ni source for growth of the catalyst. Method 200 further comprises, at 230, leaving the Ni foam in the solution at ambient temperature for a time duration in a range of from about 0.5 hour to about 4 hours to provide a treated foam. During the time duration, the catalyst is grown on the substrate; that is, at the end of the time duration, the catalyst has grown on the substrate. The catalyst does not necessarily grow for the entire time duration, depending on the time duration length and the substrate satiation. Method 200 can further comprise, at 240, removing the treated foam from the solution after the time duration, wherein the treated foam comprises the catalyst grown thereon.

The catalyst can be an iron-based(oxy)hydroxide catalyst. In aspects, the catalyst comprises a nickel iron (NiFe) layered double hydroxide (NiFe LDH) catalyst, a cobalt/iron (CoFe) LDH catalyst, or an iron (oxy)hydroxide (FeOOH) catalyst. In exemplary embodiments, the catalyst is a LDH. For example, in embodiments, the catalyst comprises NiFe LDH, as detailed hereinbelow, a CoFe LDH catalyst. In embodiments, the catalyst comprises an FeOOH catalyst. Although details are provided with regard to the NiFe LDH catalyst, different (or no) other divalent cation salts can be utilized to form a variety of catalysts via the method of this disclosure.

Dissolving the amount of the Fe²⁺ source and optionally the amount of the salt of the another divalent cation in the deionized water at ambient temperature at 210 can include various amounts of the Fe²⁺ source and/or the optional salt of the another cation. For example, in embodiments, dissolving can comprise dissolving an amount of from about 0.01x to about 2x from about 0.001x to about 2x, from about 0.01x to about 1x, from about 0.01x to about 1.5x, from about 0. 1x to about 2x, or greater than, less than, or equal to about 2, 1.5, 1, 0.5, 0.4, 0.3, 0.2, 0.15, 0.1, 0.01, or 0.001 × moles of the Fe²⁺ source and/or moles of the salt of the another cation in x L of deionized water. For example, in some specific embodiments, the solution comprises the Fe²⁺ source at a concentration of approximately 0.1, 0.15, or 0.2 molar (M), and optionally the salt of the another divalent cation at a concentration of approximately 0.1, 0.15, or 0.2 M.

The amounts of the Fe²⁺ source and any optional salt of another cation dissolved in the deionized water at 210 can be increased proportionally as the volume of deionized water is increased. Generally, for a value x, from about 0.01x to about 2x moles of Fe²⁺ source (e.g., FeSO₄• 7H₂O) and from about 0.01x to about 2x moles of the salt of the another divalent cation (e.g., Ni(NO₃)₂ • 6H₂O, Co(NO₃)₂ • 6H₂O), if any, can be dissolved in 1000x mL of deionized water.

Placing the (e.g., piece of) Ni foam into the solution at ambient temperature at 220 can comprise various sizes and/or shapes of Ni foam. For example, the piece of Ni foam can, in embodiments, range from 0.5 cm × 1 cm through 8 cm × 10 cm, which corresponds to a single-side surface area of 0.5 cm² through 80 cm². Other sizes of Ni foam can also be used, and the Ni foam placed in the solution at 220 can be larger or smaller than the exemplary piece. Generally, continuing with the example above using the value x, a piece of Ni foam having single-side surface area between 0.5x cm² up to 80x cm² can be placed in the solution. Other sizes of Ni foam can be placed in the solution. The Ni foam serves as the substrate, and can also, in embodiments, serve as a Ni source for the growth of the catalyst, for example when the catalyst comprises NiFe LDH.

The duration time can be in a range of from about of ten minutes to about 4 hours, in embodiments, although longer time durations may be utilized, in some embodiments. Generally, the foam can be removed after a shorter duration when the amounts of Fe²⁺ source (e.g., FeSO₄•7H₂O) and/or optional salt of the another divalent cation (e.g., Ni(NO₃)₂ • 6H₂O, Co(NO₃)₂ • 6H₂O, etc.) are higher, and the foam can be removed after a longer duration time when the amounts of such chemicals are lower. Optionally, the treated foam can be washed with deionized water after it is removed from the solution at 240. As indicated at 250, the treated foam having the catalyst grown thereon can, in embodiments, be utilized directly as an OER electrode.

The illustrated synthesis operation is fast (typically less than 4, 3, 2, 1, or 0.5 hours) and is conducted at ambient temperature, which makes the synthesis both time-efficient and energy-efficient. Moreover, the illustrated synthesis operation is scalable and, thus, is suitable for large-scale applications. As previous mentioned in connection with FIG. 1, when the resulting catalysts are directly used as OER electrodes in the exemplary electrolyzer of FIG. 1, operated with seawater as electrolyte 130, current densities of 200 and 500 mA cm⁻² at voltages of less than about 2V (e.g., 1.533 and 1.665 V), respectively, can be achieved for production of hydrogen, which satisfy industrial criteria.

The Fe²⁺ source can be any suitable Fe²⁺ source. For example, in embodiments, the Fe²⁺ source can comprise FeSO₄•7H₂O.

In aspects, the Fe²⁺ source comprises FeSO₄•7H₂O, the method does not comprise dissolving the optional amount of the salt of the another divalent cation at 210, and the catalyst comprises the FeOOH catalyst.

In aspects, the method does comprise dissolving the amount of the salt of the another divalent cation in the deionized water at ambient temperature to form the solution, the another divalent cation comprises nickel, and the catalyst comprises the NiFe LDH catalyst. In some such aspects, the Fe²⁺ source can comprise FeSO₄•7H₂O, the salt of the another divalent cation can comprise Ni(NO₃)₂•6H₂O, or the Fe²⁺ source can comprise FeSO₄•7H₂O, and the salt of the another divalent cation can comprise Ni(NO₃)₂•6H₂O.

In embodiments, the method comprises dissolving the amount of the Fe²⁺ source and the salt of the amount of the another divalent cation in the deionized water at ambient temperature to form the solution, the another divalent cation comprises cobalt, and the catalyst comprises the CoFe LDH catalyst. In some such aspects, the Fe²⁺ source comprises FeSO₄•7H₂O_{,}the salt of the another divalent cation comprises Co(NO₃)_{2•}6H₂O,or the Fe²⁺ source comprises FeSO₄•7H₂O_{,}and the salt of the another divalent cation comprises Co(NO₃)₂• 6H₂O.

In embodiments, method 200 further comprises, at 250, using the treated foam comprising the catalyst directly (i.e., without further surface modification) as an oxygen evolution reaction (OER) electrode. In embodiments, the Ni foam having the catalyst grown thereon is rinsed, for example, in deionized water prior to use.

In embodiments, method 200 can further comprise, at 205, treating the Ni foam to improve (i.e., increase) a hydrophilicity thereof prior to placing the nickel foam into the solution at 220. For example, in embodiments, method 200 comprises immersing the Ni foam in acid at 205 to improve the hydrophilicity of the Ni foam prior to placing the Ni foam into the solution at 220. Any suitable method can be utilized to increase the hydrophilicity of the Ni foam surface. In aspects, the acid into which the Ni foam is immersed to increase the hydrophilicity of the surfaces thereof comprises hydrochloric acid (HCl).

Also described herein is a catalyst for water electrolysis produced via the method of this disclosure. For example, provided herein are a NiFe LDH catalyst, a CoFe LDH catalyst, a FeOOH catalyst, and other catalysts produced via method 200, with various (or no) salts of the another divalent cation. Also provided herein is a water electrolyzer, such as depicted in FIG. 1, comprising: an anode 110 formed by an electrode comprising the catalyst of this disclosure; and a cathode 120. For example, in aspects, the anode comprises an NiFe LDH electrode, a CoFe LDH electrode, a FeOOH electrode, or an electrode comprising another catalyst produced via the herein disclosed method 200. The anode is not particularly limited. In embodiments, the cathode can comprise an NiMoN catalyst (e.g., NiMoN nanowire arrays supported on nickel (Ni) foam). For example, in embodiments, a water electrolyzer 100 of this disclosure comprises: an anode comprising a NiFe layered double hydroxide (NiFe LDH) electrode; and a cathode. In embodiments, a water electrolyzer 100 of this disclosure comprises: an anode comprising a CoFe layered double hydroxide (CoFe LDH) electrode; and a cathode. In embodiments, a water electrolyzer 100 of this disclosure comprises: an anode comprising a FeOOH (oxy)hydroxide electrode; and a cathode. The cathode can comprise, for example, NiMoN nanowire arrays on nickel (Ni) foam, or another suitable electrode comprising a HER catalyst. The anode of the water electrolyzer can be formed via the herein disclosed method (e.g., method 200 described with reference to FIG. 2).

The water electrolyzer 100 according to this disclosure can further comprise an electrolyte 130. The catalyst of this disclosure can be particularly useful for applications in which the electrolyte 130 comprises alkaline natural seawater electrolyte. However, in embodiments, the electrolyte 130 can be a freshwater or a seawater electrolyte, or a combination of both freshwater and seawater.

In embodiments, a voltage 140 between the anode 110 and the cathode 120 of less than about two volts provides a current density of at least 500 mA cm⁻². In embodiments, a voltage 140 of approximately 1.665 volts between the anode 110 and the cathode 120 of the water electrolyzer 100 provides the current density of at least 500 mA cm⁻². In embodiments, a voltage 140 between the anode 110 and the cathode 120 for providing a current density of 500 mA cm⁻² remains below 2 volts throughout one-hundred hours of continuous water electrolysis via the water electrolyzer 100 of this disclosure. In embodiments, the voltage 140 for providing the current density of 500 mA cm⁻² changes by less than about 0.05, 0.48, or 0.047 mV during the one-hundred hours of continuous water electrolysis via the water electrolyzer 100 of this disclosure.

In embodiments, the electrode of this disclosure comprising the catalyst produced via method 200 is capable of delivering at least one of: a current density of 100 mA cm⁻² at an overpotential of less than or equal to about 250, 249, 248, or 247 mV, a current density of 200 mA cm⁻² at an overpotential of less than or equal to about 270, 269, 268, 267, or 266 mV, or a current density of 500 mA cm⁻² at an overpotential of less than or equal to about 300, 299, 298, 297, or 296 mV.

In some specific embodiments, a method for ambient-temperature synthesis of a catalyst for water electrolysis comprises: dissolving, at 210, an amount of FeSO₄•7H₂O and an amount of Ni(NO₃)₂•6H₂O in deionized water at ambient temperature to form a solution; placing nickel (Ni) foam into the solution, at 220, whereby the Ni foam serves as a substrate and/or a Ni source for growth of a NiFe layered double hydroxide (NiFe LDH) catalyst; leaving the Ni foam in the solution, at 230, at ambient temperature for a time duration in a range of from about 0.5 hour to about 4 hours to provide a treated foam, wherein during the time duration the NiFe LDH catalyst is grown on the substrate/Ni foam; and removing the treated foam from the solution after the time duration, at 240, wherein the treated foam comprises the NiFe LDH catalyst. The amounts of the FeSO₄•7H₂Oand Ni(NO₃)₂•6H₂O dissolved in the deionized water at 210 can be within the ranges noted hereinabove. For example and without limitation, in embodiments, the solution comprises about 0.15 molar (M) FeSO₄•7H₂O and 0.15 M Ni(NO₃)₂•6H₂O.

In other specific embodiments, a method for ambient-temperature synthesis of a catalyst for water electrolysis comprises: dissolving, at 210, an amount of FeSO₄•7H₂O and an amount of Co(NO₃)₂ • 6H₂O in deionized water at ambient temperature to form a solution; placing nickel (Ni) foam into the solution, at 220, whereby the Ni foam serves as a substrate for growth of a CoFe layered double hydroxide (CoFe LDH) catalyst; leaving the Ni foam in the solution, at 230, at ambient temperature for a time duration in a range of from about 0.5 hour to about 4 hours to provide a treated foam, wherein during the time duration the CoFe LDH catalyst is grown on the substrate/Ni foam; and removing the treated foam from the solution after the time duration, at 240, wherein the treated foam comprises the CoFe LDH catalyst. The amounts of the FeSO₄•7H₂Oand Co(NO₃)₂•6H₂O dissolved in the deionized water at 210 can be within the ranges noted hereinabove. For example and without limitation, in embodiments, the solution comprises about 0.15 molar (M) FeSO₄•7H₂O and 0.15 M Co(NO₃)₂•6H₂O.

In other specific embodiments, a method for ambient-temperature synthesis of a catalyst for water electrolysis comprises: dissolving, at 210, an amount of FeSO₄•7H₂Oin deionized water at ambient temperature to form a solution; placing nickel (Ni) foam into the solution, at 220, whereby the Ni foam serves as a substrate for growth of a FeOOH (oxy)hydroxide catalyst; leaving the Ni foam in the solution, at 230, at ambient temperature for a time duration (e.g., in a range of from about 0.5 hour to about 4 hours) to provide a treated foam, wherein during the time duration the FeOOH catalyst is grown on the substrate/Ni foam; and removing the treated foam from the solution after the time duration, at 240, wherein the treated foam comprises the FeOOH catalyst. The amount of the FeSO₄•7H₂Odissolved in the deionized water at 210 can be within the ranges noted hereinabove. For example and without limitation, in embodiments, the solution comprises about 0.15 molar (M) FeSO₄•7H₂O.

In aspects of the method, the time duration is less than or equal to about 4, 3, 2, 1, or 0.5 hours. In aspects of the method, the time duration is greater than or equal to about 30, 40, 50, 60, 70, 80, 90, 100, 110, or 120 minutes. In aspects, the time duration is in a range of from about 0.5 to 4 hours, from about 1 to 3 hours, from about 1.5 to 2.5 hours, or is equal to about 0.5, 1, 1.5, or 2 hours. Although the time duration can be longer, saturation of the substrate surface with grown catalyst may result in no further improvement in catalyst loading of the substrate (e.g., Ni foam) surface after a certain time duration, such as 2 hours. Accordingly, the time duration may be a time until further catalyst growth on the substrate ceases.

FIG. 2 described an exemplary process of synthesizing the catalyst of this disclosure. The following paragraphs describe the characteristics and performance of an NiFe LDH catalyst formed by the process of FIG. 2.

### EXAMPLE: NIFE LDH CATALYST

### Experimental

Chemicals: iron (II) sulfate heptahydrate (FeSO₄•7H₂O, ≥99%, Sigma-Aldrich), nickel (II) nitrate hexahydrate (Ni(NO₃)₂•6H₂O, ≥97%, Sigma-Aldrich), cobalt (II) nitrate hexahydrate (Co(NO₃)₂•6H₂O, ≥98%, Sigma-Aldrich), sodium chloride (NaCl, FisherChemical), potassium hydroxide (KOH, 50% w/v, Alfa Aesar), ethanol (C₂H₅OH, Decon Labs, Inc.), and hydrochloric acid (HCl, 36.5-38.0 % w/w, Fisher Chemical) were used without further purification. Ni foam (thickness: 1.6 mm, porosity: ~95%) pieces were applied as substrates. Deionized (DI) water was used for all of the aqueous solutions. Seawater was obtained from Galveston Bay, Galveston, Texas, USA (29.303° N, 94.772° W). Before usage, seawater was left standing for one week to settle the visible impurities, and the supernatant was collected afterward.

Growth of NiFe LDH on the surface of nickel foam. Before usage, the nickel foam (NF) was immersed in 3 M HCl for 5 minutes to improve its hydrophilicity and then rinsed with DI water several times. Following this pretreatment, pieces of NF (1.5 × 3 cm²) were immersed in 10 mL solution of 0.15 M Ni(NO₃)₂•6H₂O and 0.15 M FeSO₄•7H₂O at room temperature for different amounts of time (from 1 to 5 h). Finally, the NF pieces were removed and placed on filter paper to dry at room temperature. The resulting electrodes are denoted as NF/NiFe LDH.

Growth of CoFe LDH and FeOOH on the surface of nickel foam. The growth of CoFe LDH and FeOOH on the surface of NF generally follows the same procedure as that for NF/NiFe LDH. Solutions of 0.15 M Co(NO₃)₂•6H₂O + 0.15 M FeSO₄•7H₂Oand of 0.15 M FeSO₄•7H₂O were employed as the reaction solutions for CoFe LDH and FeOOH, respectively. The reaction time for both CoFe LDH and FeOOH was set at 2 h. The resulting electrodes are denoted as NF/CoFe LDH and NF/FeOOH, respectively.

Electrodeposition and hydrothermal growth of NiFe LDH. All NF were immersed in 3 M HCl for 5 minutes and rinsed with DI water for several times before usage. For electrodeposition, NF was then connected to a three-electrode system with saturated Hg/HgO electrode (SCE) as a reference electrode, a graphite electrode as a counter electrode and 0.15 M Ni(NO₃)₂ • 6H₂O & 0.15 M FeSO₄•7H₂O aqueous solution as the electrolyte. During the electrodeposition, the applied potential was set as -1.0 V vs. SCE and the electrodeposition time was 120 s. For the hydrothermal growth of NiFe LDH, 0.5 mmol Ni(NO₃)₂ • 6H₂O, 0.5 mmol Fe(NO₃)₃ • 9H₂O, 3 mmol urea, and 3.75 mmol NH₄ F were dissolved into 60 mL DI water first. Then the aqueous solution and a piece of 3 × 2 cm² NF were transferred into a 100 mL Teflon-lined stainless-steel autoclave. The autoclave was sealed and maintained at 120° C. for 6 hours and then cooled down to room temperature naturally. The as-prepared sample was rinsed with DI water and dry at room temperature then the NF/NiFe LDH electrode was obtained by the hydrothermal method.

Preparation of NiMo nitride (NiMoN) on the surface of nickel foam. To prepare the NiMoN on the surface of NF, a well-established hydrothermal method was first applied to synthesize NiMoO₄ on the NF surface. A solution of 50 mL 0.04 M Ni(NO₃)₂•6H₂O and 0.01 M (NH₄)6Mo7O24•4H₂O was prepared and transferred into a 100 mL autoclave. A 2 × 5 cm² piece of NF (previously cleaned by ethanol and DIwater several times) was placed in the autoclave. The autoclave was then transferred into a furnace and kept at 150° C. for 6 h. After the autoclave cooled down to room temperature, the prepared NF/NiMoO₄ was washed with DI water several times and then dried at 60° C. overnight under vacuum. Finally, the NF/NiMoO₄ was transferred into a tube furnace for the thermal nitridation process, which was performed under 500° C. for 1 h with a gas flow of 120 standard cubic centimeters (sccm) NH₃ and 30 sccm Ar. The resulting electrode is denoted as NF/NiMoN and was applied as the cathode for two-electrode water splitting.

Preparation of IrO₂ on the surface of nickel foam. A mixture of 40 mg IrO₂, 60 µL Nafion, 540 µL ethanol, and 400 µL DI water was sonicated for 10 minutes. A piece of NF was pretreated (treated by 3 M HCl for 5 minutes and rinsed by DI water) and then immersed in the solution for 1 h, after which the active materials were coated on the NF surface. The electrode was then removed and placed on filter paper to dry at room temperature.

Material characterization. Scanning electron microscopy (SEM) and transmission electron microscopy (TEM) were conducted using a LEO 1525 SEM and a JEOL 2010F TEM, respectively. X-ray electron dispersive spectroscopy (EDS) was conducted using the JEOL 2010F TEM. X-ray photoelectron spectroscopy (XPS) was conducted using a PHI Quantera XPS scanning microprobe. Raman measurements were conducted using a homemade Raman microscope utilizing a light source of 532 nm with power of 10 mW and exposure time of 120 s.

Electrochemical characterization. Electrochemical measurements were obtained using a Gamry Reference 600 electrochemical workstation. Linear sweep voltammetry (LSV), OER stability testing and electrochemical impedance spectroscopy (EIS) were conducted on a three-electrode configuration in which a graphite electrode served as the counter electrode, a Hg/HgO electrode served as the reference electrode, and a synthesized sample served as the working electrode. The scan rate for the activity tests was 2 mV/s and the back scanning (from high to low potential) was utilized during LSV in order to characterize the activity and avoid overestimation. The current-interrupt (CI) method was utilized to introduce iR compensation. All potentials were converted into the reversible hydrogen electrode (RHE) by the equation: E_{RHE} = E_{Hg/HgO} + 0.098 + 0.0591 × pH for the convenience of comparison. The pH value of each of the different electrolytes (1 M KOH, 1 M KOH and 0.5 M NaCl, 1 M KOH and 1 M NaCl, and 1 M KOH and seawater) was approximately 14. The chronopotentiometric technique was applied to measure the stability of the as-prepared samples under current densities of 200 and 500 mA/cm² in different electrolytes. EIS was performed at the overpotential of 300 mV for OER from 0.1 Hz to 100 kHz. In the two-electrode configuration, NF/NiMoN and NF/NiFe LDH were used as the cathode and the anode, respectively.

Faradaic efficiency evaluation. Faradaic efficiency evaluation was conducted using a sealed two-electrode configuration with 1 M KOH and seawater as the electrolyte. NF/NiMoN and NF/NiFe LDH were respectively used as the cathode and the anode, the geometrical area of each of which was about 0.5 cm². A chronopotentiometric test was performed under a current density of 250 mA/cm² in order to generate hydrogen and oxygen. The generated gas products were collected in graduated cylinders filled with water, and the change in the water level in each cylinder indicates the amount of the corresponding gas product generated within a certain amount of time. The water levels were recorded every ten minutes to track the generation of H₂ and O₂. To evaluate to faradaic efficiency, theoretical predictions of H₂ and O₂ production were calculated as follows:

$${H}_{2} P r o d u c t i o n = \frac{I t}{2 e {N}_{A}} \times 24.0 L / m o l , \text{and}$$

$${O}_{2} P r o d u c t i o n = \frac{I t}{4 e {N}_{A}} \times 24.0 L / m o l ,$$

where I is the current, t is the time, e is the elementary charge, and N_{A} is Avogadro’s constant. The temperature in our lab was about 20° C., so the molar volume of H₂ and O₂ gas was about 24.0 L/mol. The faradaic efficiency was calculated using the following equation:

$$F E = \frac{E x p e r i m e n t a l g a s p r o d u c t i o n}{T h e o r e t i c a l g a s p r o d u c t i o n} .$$

### Experimental Results

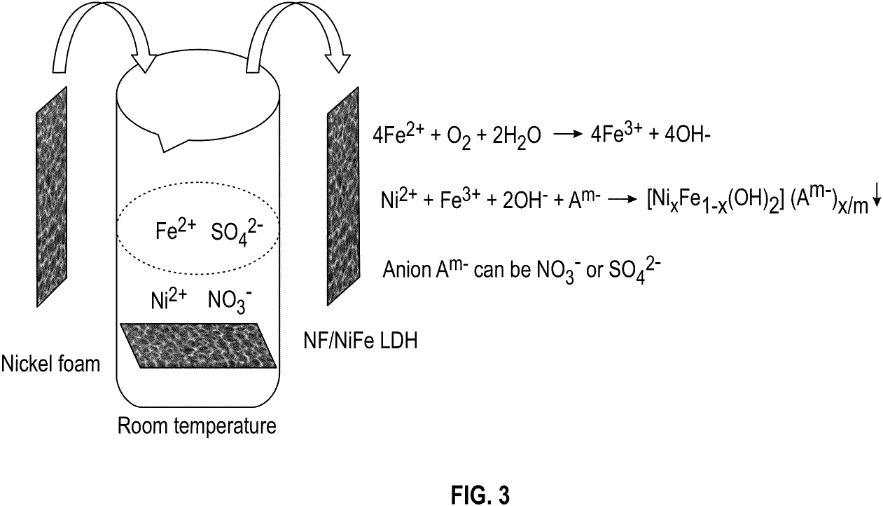

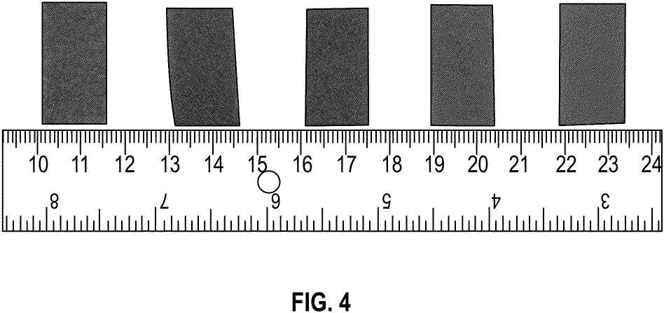

The spontaneous growth of NiFe LDH at room temperature is schematically illustrated in FIG. 3, which is a schematic illustration of, and explanation of the underlying mechanism for, the spontaneous growth of NiFe LDH at room temperature. In general, a piece of NF was immersed in a solution of 0.15 M Ni(NO₃)₂•6H₂O and 0.15 M FeSO₄•7H₂O for several hours at room temperature and NiFe LDH was spontaneously grown on the NF surface based on the mechanism shown in FIG. 3, in which the oxidation of Fe²⁺ is the main driving force for the spontaneous growth. Optical images of samples prepared with different amounts of immersion time are displayed in FIG. 4, which is a picture of NF/NiFe LDH samples prepared with different amounts of immersion time. The sample labeled 0 h in FIG. 4 is pure NF. FIG. 4 thus shows the apparent color changes with increasing immersion time.

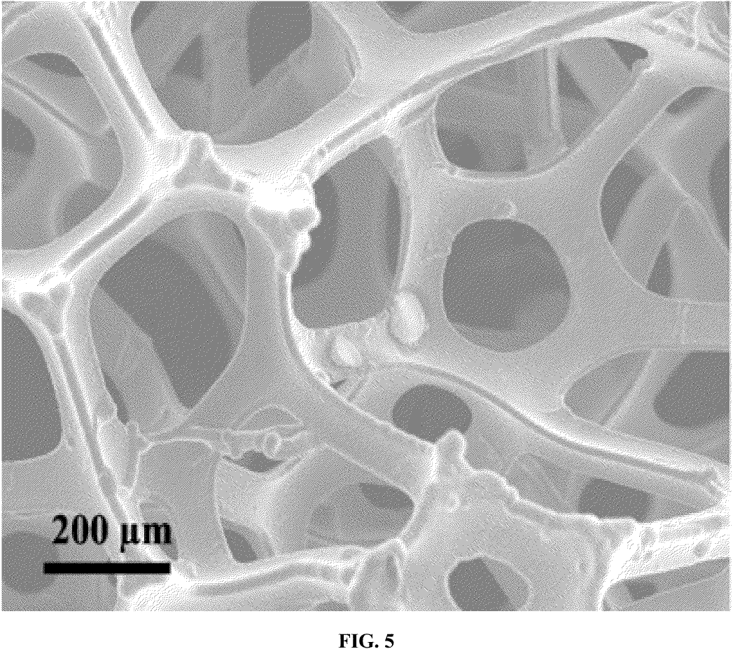

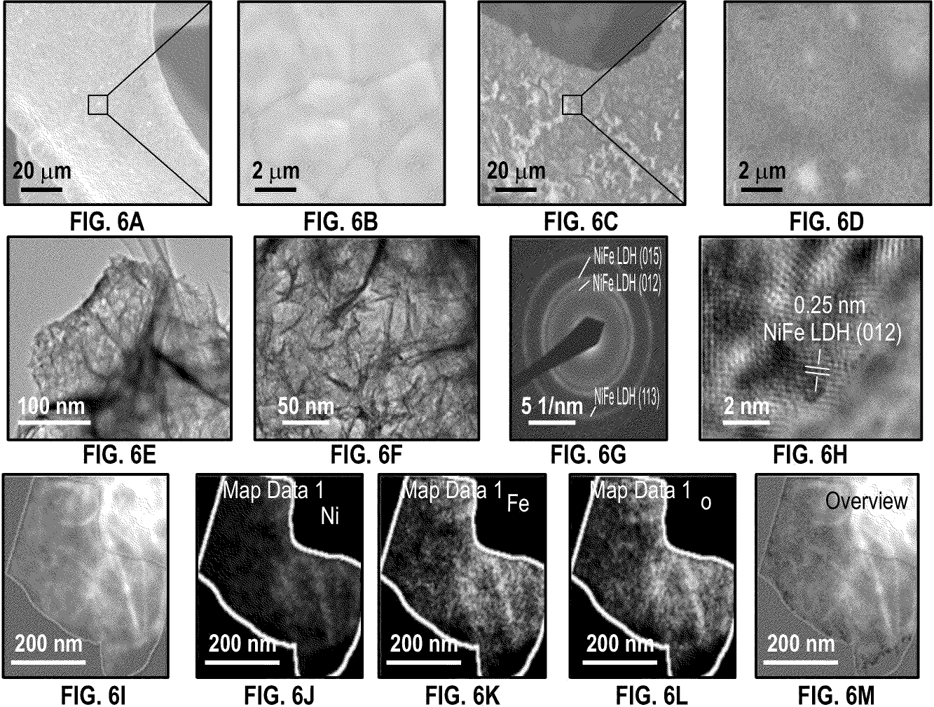

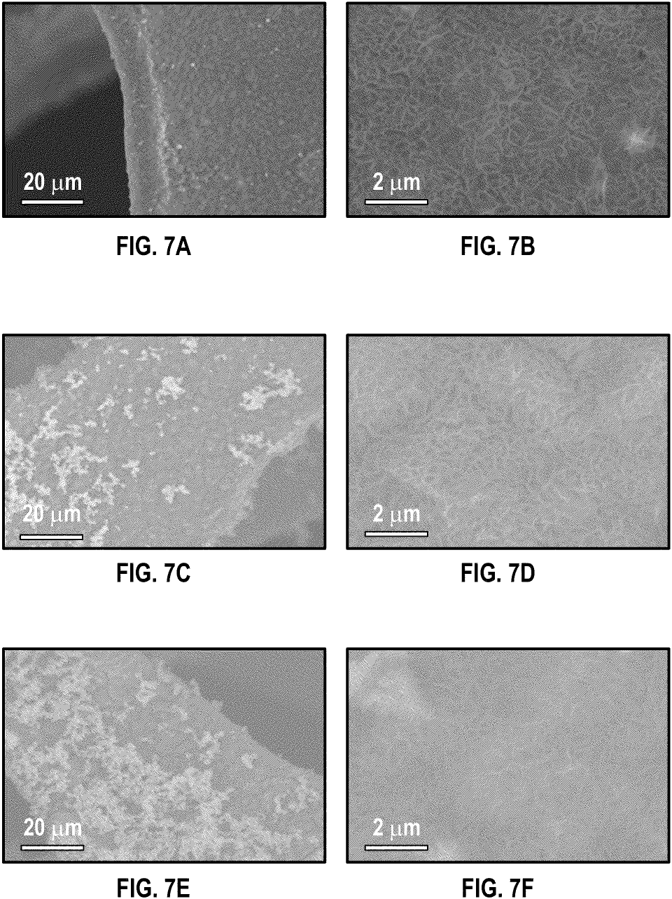

Scanning electron microscopy (SEM) was employed to characterize the nanostructure of the as-prepared samples. FIG. 5 shows the three-dimensional (3D) porous framework of the NF substrate in general, and its smooth surface was further confirmed under higher magnifications, as shown in FIGS. 6a and 6b, which depict SEM of pure NF at different magnifications. After the NF was immersed in the solution of 0.15 M Fe²⁺ and 0.15 M Ni²⁺ for 2 h, a thin layer of nanosheets was uniformly grown on its surface, as shown in FIGS. 6c and 6d, which depict SEM of NF/NiFe LDH at different magnifications. The surface features of the samples prepared with different amounts of reaction time (1, 3, and 4 h) are presented in FIG. 7, which provides SEM images of NF/NiFe LDH samples prepared with different amounts of immersion time: 7a and 7b, 1 h; 7c and 7d, 3 h; 7e, 7f, 4 h. With increasing amounts of reaction time, aggregation of NiFe LDH on the NF surface continually increased, indicating the increased loading of the NiFe LDH.

Transmission electron microscopy (TEM) was applied to further reveal the nanosheet structure and crystalline features of the as-prepared NiFe LDH (2 h sample). FIGS. 6e and 6f depict TEM of NiFe LDH at different magnifications. As shown in FIGS. 6e and 6f, the typical nanosheet structure of NiFe LDH was verified at different magnifications. FIG. 6g depicts the SAED pattern of NiFe LDH. As seen in FIG. 6g, the selective area electron diffraction (SEAD) pattern shows well-resolved diffraction rings corresponding to the (012), (015) and (113) planes of NiFe LDH. FIG. 6h depicts the high-resolution TEM image (HRTEM) of NiFe LDH. As seen in FIG. 6h, the HRTEM image shows the lattice fringes of the NiFe LDH planes with an interplanar distances of 0.25 nm. To determine the elemental distribution in these samples, energy-dispersive X-ray microscopy (EDX) elemental mapping was conducted and the results are shown in FIGS. 6i-6m. FIG. 6i depicts the TEM image of NiFe LDH for EDX mapping; FIGS. 6j-6m provide overview elemental mapping.

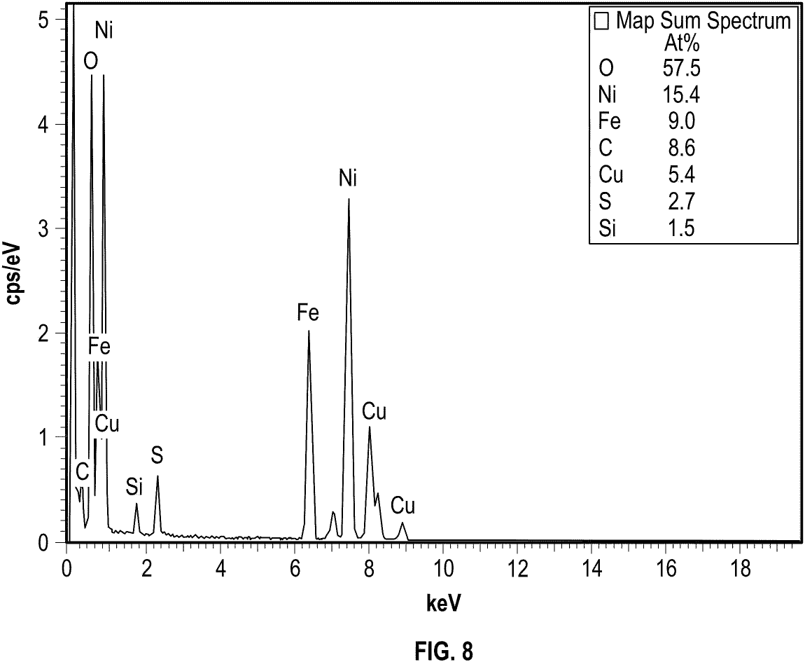

The EDX elemental mapping images clearly prove the uniform distribution of elemental Ni, Fe, and O. FIG. 8 depicts the map sum spectrum of EDX mapping. The map sum spectrum of EDX mapping displayed in FIG. 8 shows that the Ni/Fe ratio of the sample is about 5/3.

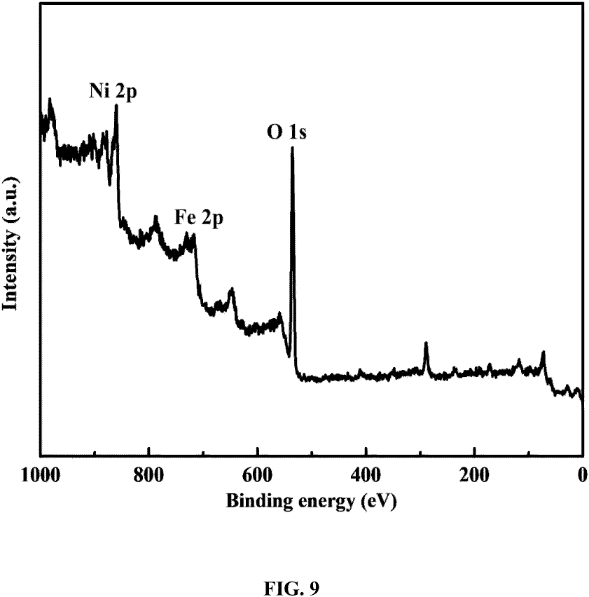

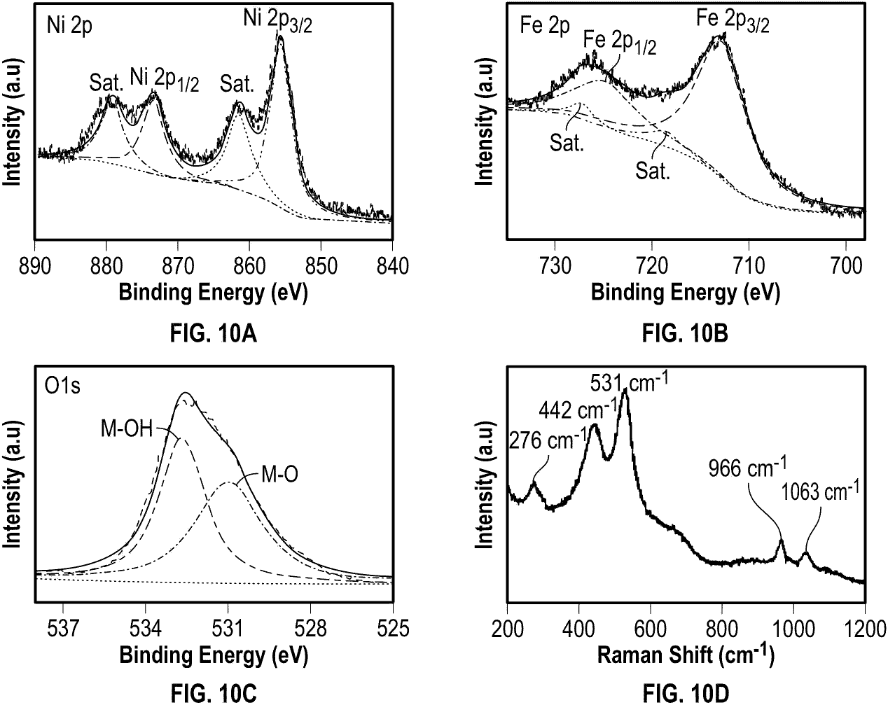

X-ray photoelectron spectroscopy (XPS) was utilized to explore the surface composition and elemental states of this NF/NiFe LDH electrode. FIG. 9 depicts the XPS survey spectrum of NF/NiFe LDH. The survey spectrum in FIG. 9 confirms the coexistence of elemental Ni, Fe, and O on the surface of the NF/NiFe LDH electrode. FIGS. 10a-10c depict the high-resolution XPS spectra of NF/NiFe LDH: FIG. 10a depicts Ni 2p, FIG. 10b depicts Fe 2p, and FIG. 10c depicts O 1s. In FIG. 10a, the peaks at 855.8 and 873.6 eV correspond to the Ni 2p3/2 and Ni 2p1/2 orbits, respectively, and two satellite peaks at 861.5 eV and 879.3 eV can also be observed, and these results indicate the Ni²⁺ oxidation state. The Fe 2p spectrum (FIG. 10b) shows two dominant peaks at 713.1 eV (Fe 2p3/2) and 725.5 eV (Fe 2p1/2) and two satellite peaks at 718.9 and 727.5 eV, which are the typical characteristics of the Fe³⁺ oxidation state. The O 1 s spectrum of FIG. 10c displays metal-O (M-O) and metal-OH (M-OH) peaks located at 531.0 and 532.7 eV, respectively, indicating the existence of the LDH species. To further confirm the successful fabrication of NiFe LDH, Raman spectroscopy was employed, and the results were analyzed. FIG. 10d depicts the Raman measurement of NF/NiFe LDH. As shown in FIG. 10d, three bands located at around 276, 442, and 531 cm⁻¹ are contributed by metal-O-metal (the metal can be Ni or Fe) species. The bands at around 966 and 1063 cm⁻¹ are ascribed to the metal-OOH active species. The Raman spectroscopy results correspond to a typical brucite-like LDH structure.

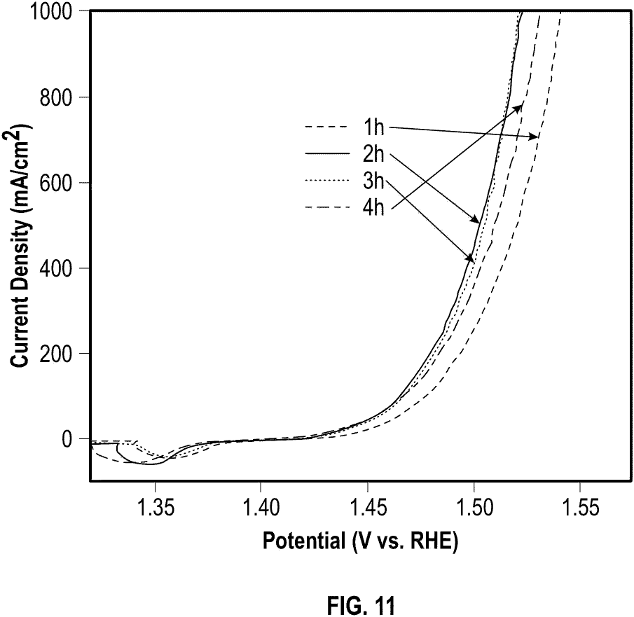

The electrochemical OER performance of these samples was first investigated in a three-electrode system using 1 M KOH as the electrolyte. Linear sweep voltammetry (LSV) with iR compensation was carried out to characterize the OER activity. FIG. 11 depicts OER performance (LSV curves) of NF/NiFe LDH samples prepared with different amounts of immersion time. The LSV curves of NF/NiFe LDH electrodes prepared with different amounts of reaction time displayed in FIG. 11 show that there was no significant improvement in the OER performance after 2 h immersion. Since further increasing the immersion time will be time consuming, a 2 h immersion (or “duration time”) was determined to be the optimal reaction time and was used for further analysis unless otherwise indicated. It is also worth mentioning that the loading of NiFe LDH on the surface of NF reached saturation after 2 h of immersion, so further increasing the loading does not help to increase extra active sites and the OER performance.

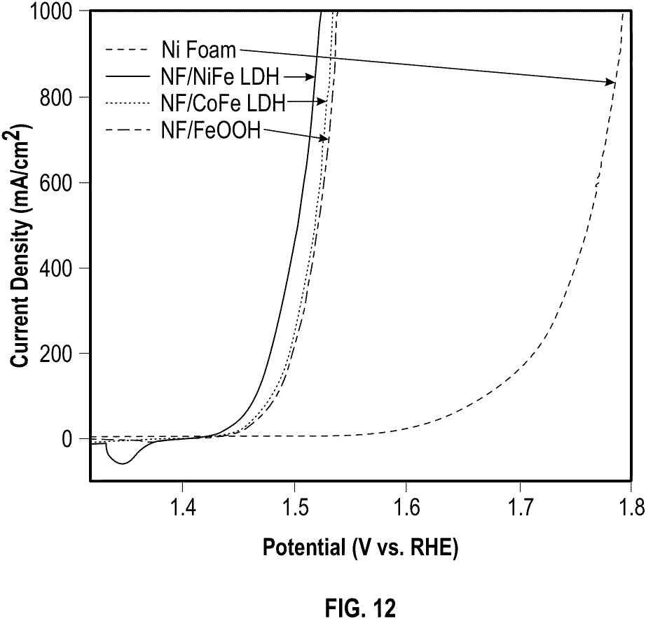

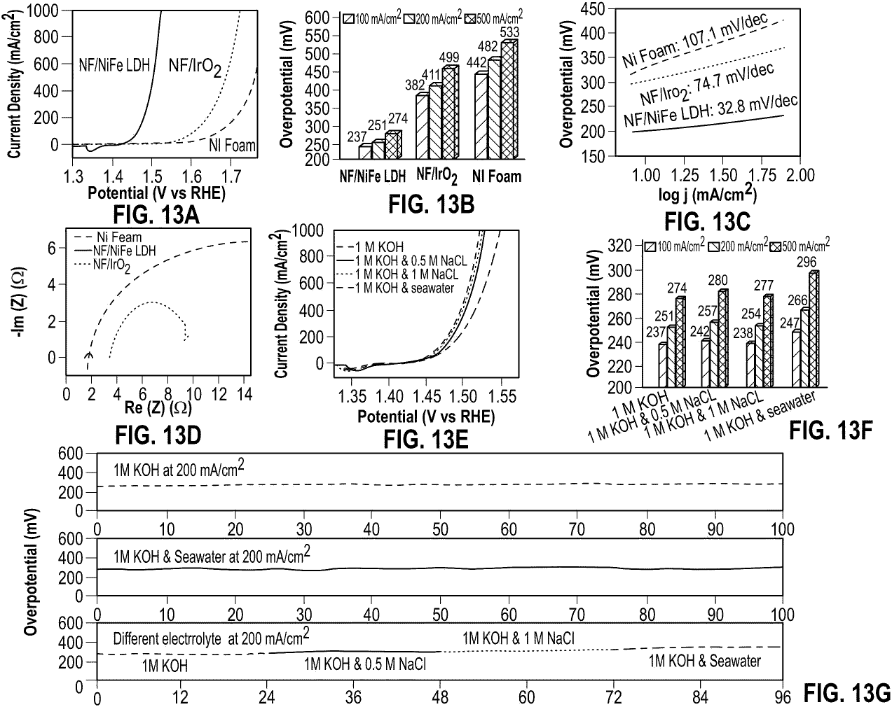

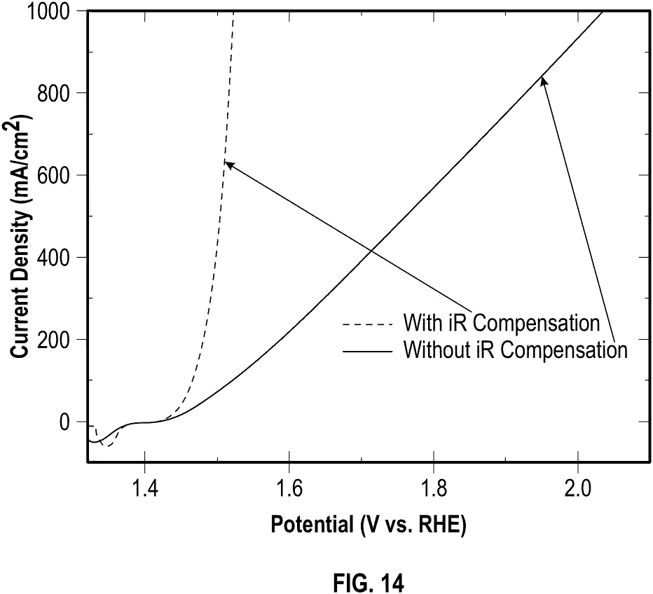

To verify the versatility of the Fe²⁺-driven fabrication of this disclosure, NF/CoFe LDH and NF/FeOOH samples were fabricated as examples and the OER performance thereof is shown in FIG. 12, which depicts the OER performance (LSV curves) of different samples prepared using the herein disclosed Fe²⁺-driven fabrication. The results of FIG. 12 confirm the very good activity of the catalysts fabricated via the herein disclosed Fe²⁺-driven fabrication method 200. FIG. 13a shows the OER performance (LSV curves), FIG. 13b depicts the overpotentials required to achieve different current densities, FIG. 13c depicts the Tafel slopes, and FIG. 13d depicts EIS for different electrodes in 1 M KOH. FIG. 13e depicts the OER performance (LSV curves) of NF/NiFe LDH in different electrolytes, FIG. 13f depicts the overpotentials required to achieve different current densities for NF/NiFe LDH in different electrolytes, and FIG. 13g depicts long-term OER stability tests of NF/NiFe LDH at different current densities in different electrolytes. The OER activity values of different electrodes are compared in FIG. 13a. After 2 h treatment at room temperature, NF/NiFe LDH was found to exhibit a significant OER enhancement compared with the original NF, and it is also superior to the benchmark catalyst IrO₂. Note that the reduction peak of NF/NiFe LDH around 1.35 V vs. RHE in FIG. 11, FIG. 12, and FIG. 13a is originated from Ni³⁺ to Ni²⁺ transformation. NF/NiFe LDH requires only a very low overpotential of 202 mV to reach a current density of 10 mA/cm², while overpotentials of 304 mV and 331 mV are required for NF/IrO₂ and nickel foam, respectively, in order to reach the same current density. To achieve higher current densities of 100, 200, and 500 mA/cm², the needed overpotentials are 237, 251, and 274 mV, respectively, for NF/NiFe LDH, which significantly outperforms both NF/IrO₂ and NF, as shown in FIG. 13a and FIG. 13b. The LSV curve of NF/NiFe LDH without iR compensation is also shown in FIG. 14 for comparison.

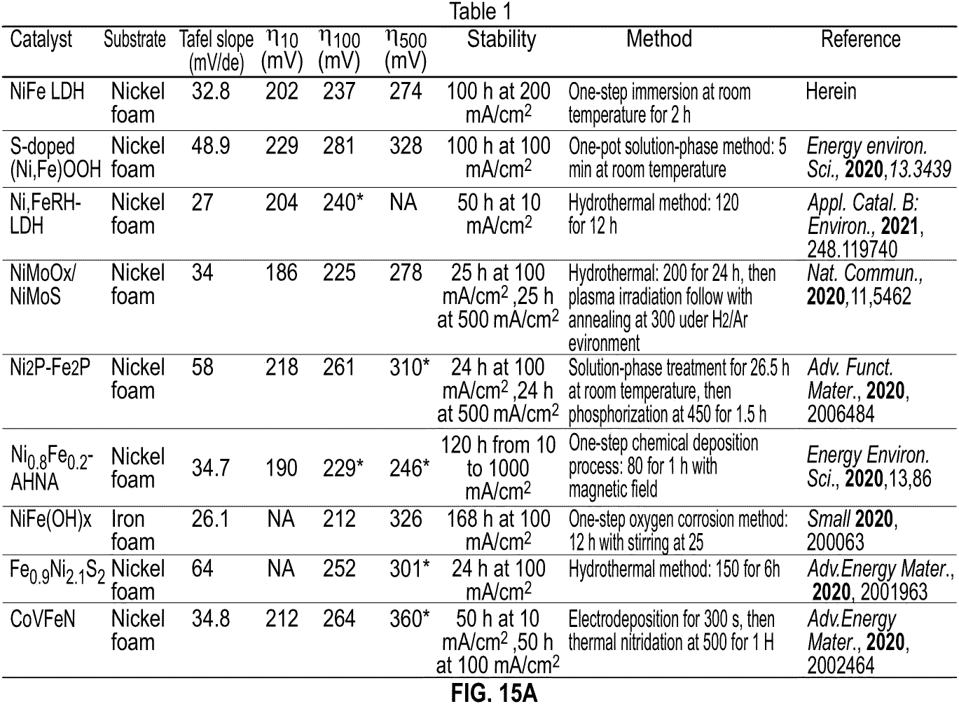

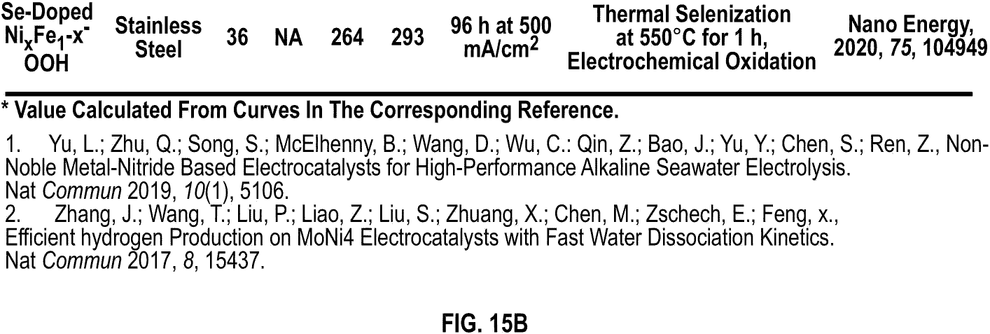

The Tafel slopes of the three electrodes shown in FIG. 13c, show that the NF/NiFe LDH exhibits the lowest Tafel slope of 32.8 mV/dec, indicating its outstanding intrinsic activity. Remarkably, the OER activity of the NF/NiFe LDH achieved via the herein disclosed method 200 makes it among the best transition-metal-based OER catalysts in alkaline electrolyte (1 M KOH), as shown in Table 1 of FIG. 15A and FIG. 15B, which tabulates OER activity and synthesis method comparison between the NF/NiFe LDH catalyst described herein and other recently reported state-of-the-art OER catalysts in 1 M KOH electrolyte. η₁₀, η₁₀₀, and η₅₀₀ are overpotentials required to achieve current densities of 10, 100, and 500 mA/cm², respectively.

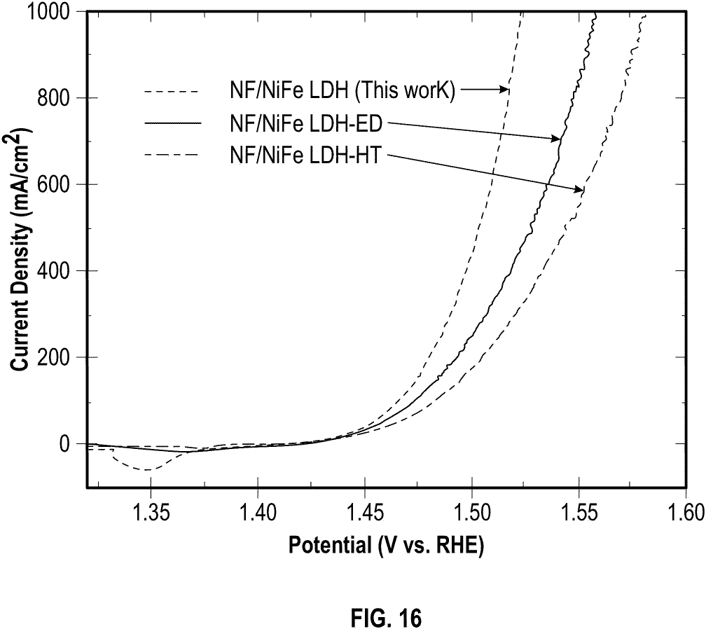

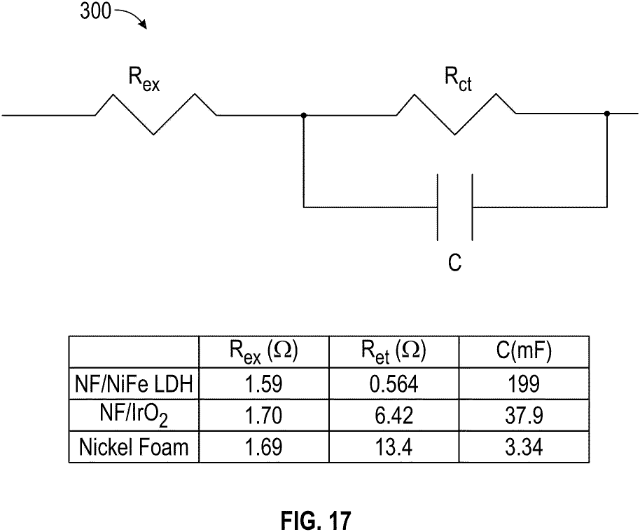

More importantly, compared with those for other state-of-the-art transition-metal catalysts, the synthesis method 200 described herein is much more cost effective since it does not require high energy input or any other additives. The main driving force for the fabrication method 200 of this disclosure is the oxidation of Fe²⁺ at room temperature. To further prove the advantages of our NiFe LDH catalyst prepared by the method 200 of this disclosure, NiFe LDH on Ni foam was synthesized via conventional electrodeposition method (ED) and hydrothermal method (HT) for comparison. FIG. 16 provides the OER performances (LSV curves) of NF/NiFe LDH fabricated by the three methods. As seen in FIG. 16, the NF/NiFe LDH fabricated by Fe²⁺-driven method 200 of this disclosure is significantly better than the other than electrodes fabricated by electrodeposition and hydrothermal methods, which confirms the extremely good OER activity of the NiFe LDH catalyst of this disclosure. Electrochemical impedance spectroscopy (EIS) was employed to characterize the charge-transfer kinetics of different catalysts. FIG. 17 shows an equivalent circuit 300 for the EIS Nyquist plots. Rₑₓ and R_{ct} are external circuit resistance and interfacial charge transfer resistance, respectively; C is interface capacitance. All data were acquired from Zview fitting. In FIG. 13d and FIG. 17, the NF/NiFe LDH of this disclosure exhibits the lowest charge transfer resistance (R_{ct}) of about 0.564 Ω, which is much lower than that of NF/IrO₂ (~6.42 Ω) and pure NF (~13.4 Ω), demonstrating a more efficient charge transfer thereof between the electrolyte and the catalyst surface.

The OER performance of the NF/NiFe LDH electrode of this disclosure in alkaline simulated seawater (1 M KOH and 0.5 M NaCl, and 1 M KOH and 1 M NaCl) and alkaline natural seawater (1 M KOH and seawater) electrolytes was evaluated. As displayed in FIG. 13e and FIG. 13f, compared with its activity in 1 M KOH, the NF/NiFe LDH of this disclosure exhibits no obvious degradation in alkaline simulated seawater, and even shows slightly better performance in higher salinity (1 M KOH and 1 M NaCl). Without wishing to be limited by theory, this may be due to the higher ionic concentration that contributes to higher conductivity. In alkaline natural seawater, the activity of OER catalysts usually suffers due to the poisoning effect of the complex soluble and insoluble impurities in natural seawater. Notably, the NF/NiFe LDH electrode of this disclosure was exhibited good resistance to the poisoning effect of natural seawater. The additional overpotentials required to achieve current densities of 100, 200, and 500 mA/cm² were only 10, 15, and 22 mV, respectively, compared with those for 1 M KOH electrolyte. Importantly, the overpotential required to achieve a large current density of 500 mA/cm² in alkaline natural seawater electrolyte (1 M KOH and seawater) was only 296 mV, far below the CER threshold of 480 mV, and thus hypochlorite formation can be thermodynamically suppressed via use of the electrode of this disclosure.

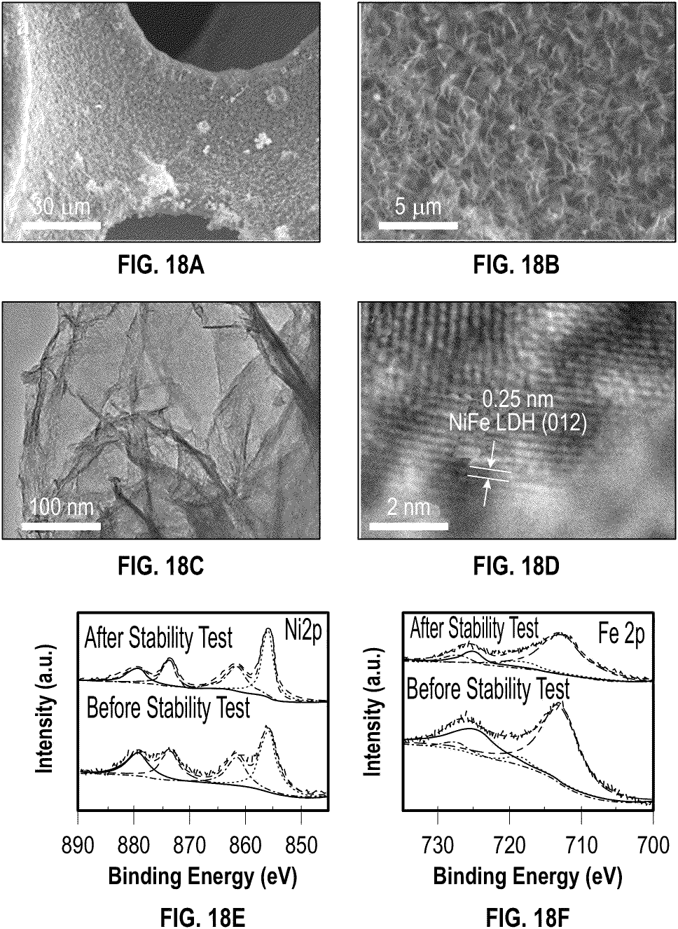

In addition to electrochemical activity, the electrochemical stability of electrodes is also of great significance for practical applications. To evaluate the electrochemical stability of the herein disclosed catalyst, stability tests were conducted on NF/NiFe LDH at a large current density of 200 mA/cm² over 100 h in alkaline fresh water (1 M KOH) and in alkaline natural seawater (1 M KOH and seawater). The OER performance remained highly stable throughout the long-term continuous testing in both electrolytes, as shown in the top and middle panels of FIG. 13g. Additionally, the SEM, TEM, and XPS of NF/NiFe LDH were measured after the stability test in alkaline natural seawater electrolyte. FIG. 18a and FIG. 18b depict the SEM images after the stability test; FIG. 18c and FIG. 18d depict the TEM images after the stability test; FIG. 18e and FIG. 18f depict the Ni 2p and Fe 2p XPS spectra, respectively, before and after the stability test. The SEM images in FIG. 18a and FIG. 18b, along with the TEM image in FIG. 18c show that the nanosheet structure of the NF/NiFe LDH was well maintained after the stability test. In addition, the lattice fringe of (012) plane for NiFe LDH can be detected in FIG. 18d after the stability test. In FIG. 18e and FIG. 18f, the Ni 2p and Fe 2p XPS spectra of the NiFe LDH sample show no significant change before and after the stability test, indicating no chemical state change after seawater OER catalysis. Therefore, these results further verify the robust physical and chemical stability of the NF/NiFe LDH of this disclosure. The stability of the NiFe LDH sample was measured under an even larger current density of 500 mA/cm² over 96 h in different electrolytes, and the results are presented in the bottom panel of FIG. 13g. Clearly, the NF/NiFe LDH electrode of this disclosure still exhibits good durability in the four different electrolytes under a very large current density, demonstrating its good potential for real application. As shown in Table 1 of FIG. 15A and FIG. 15B, the stability of the NiFe LDH sample is among the best in comparison with that of other recently reported transition-metal-based OER catalysts for water oxidation. Importantly, the synthesis method 200 for this NF/NiFe LDH electrode provided herein is facile and cost-effective, and does not rely on any energy input or additives, making it more suitable for practical applications.

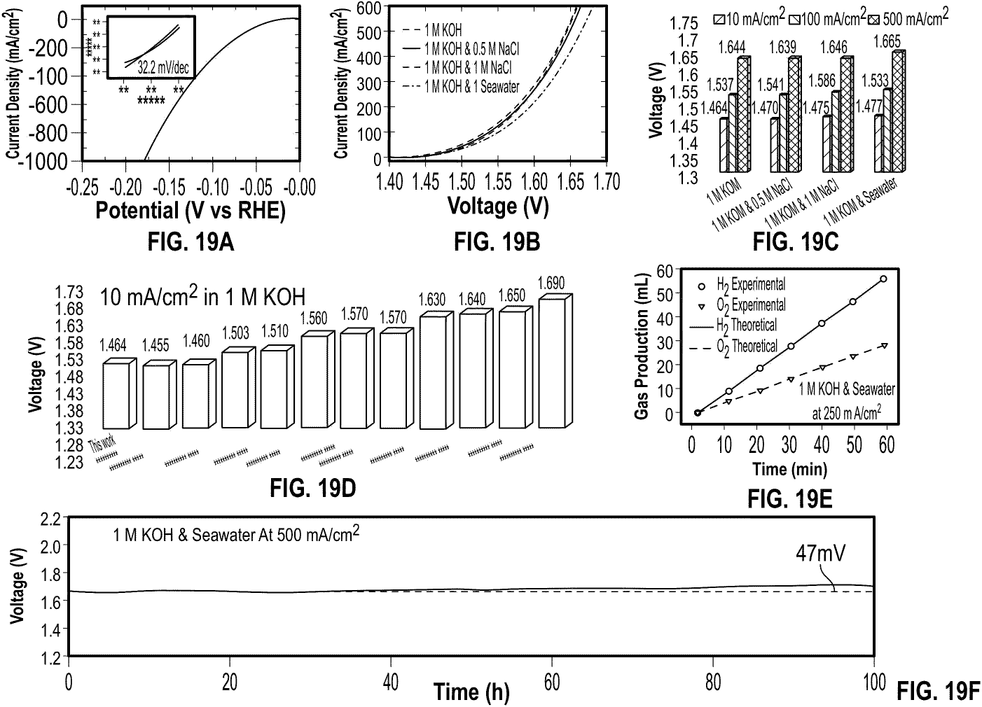

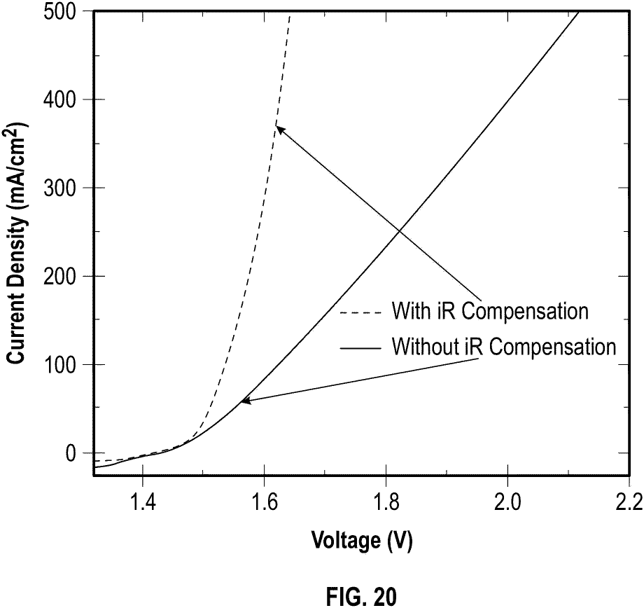

FIG. 19a depicts HER performance and (inset) Tafel slope of NF/NiMoN in 1 M KOH; FIG. 19b depicts overall seawater splitting performance of NF/NiFe LDH∥NF/NiMoN in different electrolytes; FIG. 19c depicts voltages required to drive different current densities by NF/NiFe LDH∥NF/NiMoN in different electrolytes; FIG. 19d depicts voltages required by different water electrolyzers to reach a current density of 10 mA/cm² in 1 M KOH; FIG. 19e depicts the Faradaic efficiency measurement; and FIG. 19f depicts the long-term overall seawater splitting test of NF/NiFe LDH∥NF/NiMoN in alkaline natural seawater. To evaluate the OER performance of the NF/NiFe LDH of this disclosure in overall seawater splitting, it was coupled with one of the most efficient transition-metal HER catalysts, NiMoN (FIG. 19a), in order to construct a two-electrode electrolyzer. iR-corrected LSV curves were obtained for the NF/NiFe LDH∥NF/NiMoN two-electrode configuration in different electrolytes and are presented in FIG. 19b and FIG. 19c. In the 1 M KOH electrolyte, the voltage required to deliver a current density of 10 mA/cm² was found to be only 1.464 V, making this one of the most efficient among the reported transition-metal-catalyst-based alkaline water electrolyzers (FIG. 19d). In the alkaline simulated seawater electrolytes (1 M KOH and 0.5 M NaCl, and 1 M KOH and 1 M NaCl), no obvious activity degradation was observed for the electrolyzer of this disclosure in the alkaline simulated seawater electrolytes compared with that in alkaline fresh water, as shown in FIG. 19b and FIG. 19c. In the alkaline natural seawater electrolyte (1 M KOH and seawater), the electrolyzer of this disclosure was able to deliver current densities of 10, 100, and 500 mA/cm² at small voltages of 1.477, 1.533 and 1.665 V, respectively, which is the best alkaline seawater splitting performance reported to date. At an industry-standard current density of 500 mA/cm², the activity degradation in alkaline natural seawater was found to be only about 21 mV compared with the result in alkaline fresh water, indicating the high impurity tolerance of this electrolyzer. For comparison, the overall seawater splitting performance without iR compensation is shown in FIG. 20, which depicts the overall water splitting performance of the NF/NiFe LDH∥NF/NiMoN water electrolyzer 100 of this disclosure with and without iR compensation in 1 M KOH.

To study its selectivity during seawater electrolysis, the Faradaic efficiency of the NF/NiFe LDH∥NF/NiMoN electrolyzer was measured using a sealed two-electrode configuration in 1 M KOH and seawater. A chronopotentiometric test at a constant current density of 250 mA/cm² was conducted to generate hydrogen and oxygen, and the as-generated gas products were collected in graduated cylinders filled with water. As shown in FIG. 19e, the detected amounts of hydrogen and oxygen match well with the theoretical values, indicating a Faradaic efficiency close to 100%. Therefore, the hypochlorite formation reaction was effectively suppressed under a current density as high as 250 mA/cm², demonstrating the excellent selectivity for OER by the anode catalyst of this disclosure.

To measure the stability of the NF/NiFe LDH∥NF/NiMoN electrolyzer 100, overall seawater splitting was conducted at an industry-standard current density of 500 mA/cm² for 100 h in 1 M KOH and seawater electrolyte. As shown in FIG. 19f, the NF/NiFe LDH∥NF/NiMoN electrolyzer 100 of this disclosure exhibited highly stable overall alkaline seawater splitting performance during 100 h of electrolysis, and the voltage increase after the stability test was only about 0.047 V, demonstrating good resistance of the water electrolyzer 100 to poisoning and corrosion during alkaline seawater splitting.

Electrochemical seawater splitting is a promising technique because it addresses two major challenges, clean energy production and seawater desalination, at the same time. Therefore, seeking out a facile and cost-effective way to synthesize highly active and stable seawater-splitting catalysts is of great interest to both the research community and industry. Herein disclosed is an Fe²⁺-driven, one-step, and spontaneous fabrication method for a seawater-oxygen-evolution-active NiFe layered double hydroxide (LDH) at room temperature. The NiFe LDH of this disclosure exhibits very high activity and stability toward the oxygen evolution reaction (OER) in an alkaline natural seawater electrolyte, delivering current densities of 100 and 500 mA/cm² at low overpotentials of 247 and 296 mV, respectively, and with no significant degradation observed over long-term stability testing of 96 h under a large current density of 500 mA/cm² in 1 M KOH seawater electrolyte. After coupling with a good hydrogen evolution reaction (HER) catalyst, NiMoN, the two-electrode electrolyzer of this disclosure was found to achieve current densities of 10, 100, and 500 mA/cm² at voltages of 1.477, 1.533, and 1.665 V, respectively, in alkaline natural seawater with good durability over 100 h at 500 mA/cm². The oxidation of Fe²⁺ is the driving force for the growth of NiFe LDH, and this mechanism is universal to the fabrication of other Fe-based hydroxides (e.g., CoFe LDH, FeOOH) as efficient OER catalysts.

The method 200 of this disclosure provides a cost-effective way to fabricate a very efficient OER catalyst, e.g., NiFe LDH, at room temperature. The NF/NiFe LDH catalyst of this disclosure was found to exhibit high activity and good stability towards OER in both alkaline fresh water and alkaline natural seawater. After coupling it with a NF/NiMoN cathode, an outstanding seawater electrolyzer 100, NF/NiFe LDH∥NF/NiMoN, can be provided, which displays excellent activity for alkaline natural seawater splitting, as well as good durability and high selectivity. The Fe²⁺-driven synthesis of layered double hydroxides as disclosed herein can be utilized to fabricate other good catalysts for water splitting at a very low cost, and can thus help to lower investment requirements, thus boosting the industrial application of fresh water and seawater splitting.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The phrases “in an embodiment,” “in embodiments,” “in various embodiments,” “in some embodiments,” or “in other embodiments” may each refer to one or more of the same or different embodiments in accordance with the present disclosure. The phrases “in an aspect,” “in aspects,” “in various aspects,” “in some aspects,” or “in other aspects” may each refer to one or more of the same or different aspects in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

### ADDITIONAL DISCLOSURE

The following are non-limiting, specific embodiments in accordance with the present disclosure:

In a first embodiment, a method for ambient-temperature synthesis of a catalyst for water electrolysis comprises: dissolving an amount of an Fe²⁺ source and optionally an amount of a salt of another divalent cation in deionized water at ambient temperature to form a solution; placing nickel (Ni) foam into the solution, whereby the Ni foam serves as a substrate and/or a Ni source for growth of the catalyst; leaving the Ni foam in the solution at ambient temperature for a time duration in a range of from about 0.5 hour to about 4 hours to provide a treated foam, during which time duration, the catalyst is grown on the substrate; and removing the treated foam from the solution after the time duration, wherein the treated foam comprises the catalyst grown thereon.

A second embodiment can include the method of the first embodiment, wherein the catalyst is an iron-based (oxy)hydroxide catalyst.

A third embodiment can include the method of any one of the first or second embodiments, wherein the Fe²⁺ source comprises FeSO₄•7H₂O.

A fourth embodiment can include the method of any one of the first to third embodiments, wherein the catalyst comprises a nickel/iron (NiFe) layered double hydroxide (NiFe LDH) catalyst, a cobalt/iron (CoFe) LDH catalyst, or an iron (oxy)hydroxide (FeOOH) catalyst.

A fifth embodiment can include the method of the fourth embodiment, wherein the method comprises dissolving the amount of the Fe²⁺ source and the amount of the salt of the another divalent cation in the deionized water at ambient temperature to form the solution, wherein the another divalent cation comprises nickel, wherein the Fe²⁺ source comprises FeSO₄•7H₂O_{,}and wherein the catalyst comprises the NiFe LDH catalyst.

A sixth embodiment can include the method of the fifth embodiment, wherein the salt of the another divalent cation comprises Ni(NO₃)₂ • 6H₂O.

A seventh embodiment can include the method of any one of the fourth to sixth embodiments, wherein the method comprises dissolving the amount of the Fe²⁺ source and the salt of the amount of the another divalent cation in the deionized water at ambient temperature to form the solution, wherein the another divalent cation comprises cobalt, wherein the Fe²⁺ source comprises FeSO₄•7H₂O_{,}and wherein the catalyst comprises the CoFe LDH catalyst.

An eighth embodiment can include the method of the seventh embodiment, wherein the salt of the another divalent cation comprises Co(NO₃)₂ • 6H₂O.

A ninth embodiment can include the method of any one of the fourth to eighth embodiments, wherein the catalyst comprises the FeOOH catalyst, and wherein the Fe²⁺ source comprises FeSO₄•7H₂O.

A tenth embodiment can include the method of any one of the first to ninth embodiments further comprising: using the treated foam comprising the catalyst directly as an oxygen evolution reaction (OER) electrode.

An eleventh embodiment can include the method of any one of the first to tenth embodiments, wherein dissolving the amount of the Fe²⁺ source and optionally the amount of the salt of the another divalent cation in the deionized water at ambient temperature includes dissolving 0.1x-0.5x moles of the Fe²⁺ source and 0.02x-0.5x moles of the salt of the another cation in x mL of deionized water.

In a twelfth embodiment, a catalyst for water electrolysis is produced via the method of any one of the first to eleventh embodiments.

In a thirteenth embodiment, a water electrolyzer comprises: an anode formed by a an electrode comprising the catalyst of the twelfth embodiment; and a cathode.

A fourteenth embodiment can include the water electrolyzer of the thirteenth embodiment, wherein the cathode comprises an NiMoN catalyst (e.g., NiMoN) nanowire arrays supported on nickel (Ni) foam.

A fifteenth embodiment can include the water electrolyzer of any one of the thirteenth or fourteenth embodiments further comprising an alkaline natural seawater electrolyte.

A sixteenth embodiment can include the water electrolyzer of any one of the thirteenth to fifteenth embodiments, wherein a voltage between the anode and the cathode of less than two volts provides a current density of at least 500 mA cm⁻².

A seventeenth embodiment can include the water electrolyzer of any one of the thirteenth to sixteenth embodiments, wherein the voltage is approximately 1.665 volts.

An eighteenth embodiment can include the water electrolyzer of any one of the thirteenth to seventeenth embodiments, wherein a voltage between the anode and the cathode for providing a current density of 500 mA cm⁻² remains below 2 volts throughout one-hundred hours of continuous water electrolysis.

A nineteenth embodiment can include the water electrolyzer of any one of the thirteenth to eighteenth embodiments, wherein the voltage for providing the current density of 500 mA cm⁻² changes by less than 0.047 mV during the one-hundred hours of continuous water electrolysis.

A twentieth embodiment can include the water electrolyzer of any one of the thirteenth to nineteenth embodiments, wherein the electrode is capable of delivering at least one of: a current density of 100 mA cm⁻² at an overpotential of less than or equal to about 250, 249, 248, or 247 mV, a current density of 200 mA cm⁻² at an overpotential of less than or equal to about 270, 269, 268, 267, or 266 mV, or a current density of 500 mA cm⁻² at an overpotential of less than or equal to about 300, 299, 298, 297, or 296 mV.

In a twenty first embodiment, a method for ambient-temperature synthesis of a catalyst for water electrolysis comprises: dissolving an amount of FeSO₄•7H₂Oand an amount of Ni(NO₃)₂ • 6H₂O in deionized water at ambient temperature to form a solution; placing nickel (Ni) foam into the solution, the Ni foam serving as a substrate and/or a Ni source for growth of NiFe layered double hydroxide (NiFe LDH) catalyst; leaving the Ni foam in the solution at ambient temperature for a time duration in a range of from about 0.5 hour to about 4 hours to provide a treated foam, during which time duration the NiFe LDH catalyst is grown on the substrate; and removing the treated foam from the solution after the time duration, wherein the treated foam comprises the NiFe LDH catalyst.

A twenty second embodiment can include the method of the twenty first embodiment, wherein the time duration is about 2 hours.

A twenty third embodiment can include the method of the twenty first or the twenty second embodiment further comprising immersing the Ni foam in acid to improve a hydrophilicity of the nickel foam prior to placing the Ni foam into the solution.

A twenty fourth embodiment can include the method of the twenty third embodiment, wherein the acid comprises hydrochloric acid (HCl).

In a twenty fifth embodiment, a water electrolyzer comprises: an anode comprising a NiFe layered double hydroxide (NiFe LDH) electrode; and a cathode.

A twenty sixth embodiment can include the water electrolyzer of the twenty fifth embodiment, wherein the cathode comprises NiMoN nanowire arrays on nickel (Ni) foam.

A twenty seventh embodiment can include the water electrolyzer of the twenty fifth or the twenty sixth embodiment, wherein the anode is formed by the method of any one of the twenty first to the twenty fourth embodiments.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl +k* (Ru-Rl), wherein k is a variable ranging from 1 percent to 100 percent with a 1 percent increment, i.e., k is 1 percent, 2 percent, 3 percent, 4 percent, 5 percent, ..... 50 percent, 51 percent, 52 percent, ....., 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method for ambient-temperature synthesis of a catalyst for water electrolysis, the method comprising:
dissolving an amount of an Fe²⁺ source and optionally an amount of a salt of another divalent cation in deionized water at ambient temperature to form a solution;
placing nickel (Ni) foam into the solution, whereby the Ni foam defines a substrate or a Ni source for growth of the catalyst;
leaving the Ni foam in the solution at ambient temperature for a time duration in a range of from 0.5 hour to 4 hours to provide a treated foam, during which time duration, the catalyst is grown on the substrate; and
removing the treated foam from the solution after the time duration, wherein the treated foam comprises the catalyst grown thereon.

2. The method of claim 1, wherein the catalyst is an iron-based (oxy)hydroxide catalyst.

3. The method of claim 1, wherein the Fe²⁺ source comprises FeSO₄·7H₂O.

4. The method of claim 1, wherein the catalyst comprises a nickel/iron (NiFe) layered double hydroxide (NiFe LDH) catalyst, a cobalt/iron (CoFe) LDH catalyst, or an iron (oxy)hydroxide (FeOOH) catalyst.

5. The method of claim 4, wherein the method further comprises dissolving the amount of the Fe²⁺ source and the amount of the salt of the another divalent cation in the deionized water at ambient temperature to form the solution, wherein the another divalent cation comprises nickel, wherein the Fe²⁺ source comprises FeSO₄·7H₂O, and wherein the catalyst comprises the NiFe LDH catalyst.

6. The method of claim 5, wherein the salt of the another divalent cation comprises Ni(NO₃)₂·6H₂O.

7. The method of claim 4, wherein the method further comprises dissolving the amount of the Fe²⁺ source and the salt of the amount of the another divalent cation in the deionized water at ambient temperature to form the solution, wherein the another divalent cation comprises cobalt, wherein the Fe²⁺ source comprises FeSO₄·7H₂O, and wherein the catalyst comprises the CoFe LDH catalyst, optionally wherein the salt of the another divalent cation comprises Co(NO₃)₂·6H₂O.

8. The method of claim 4, wherein the catalyst comprises the FeOOH catalyst, and wherein the Fe²⁺ source comprises FeSO₄·7H₂O.

9. The method according to claim 1, further comprising:
using the treated foam comprising the catalyst directly as an oxygen evolution reaction (OER) electrode.

10. The method according to claim 1, wherein dissolving the amount of the Fe²⁺ source and optionally the amount of the salt of the another divalent cation in the deionized water at ambient temperature includes dissolving 0.1x-0.5x moles of the Fe²⁺ source and 0.02x-0.5x moles of the salt of the another cation in x mL of deionized water.

11. A catalyst for water electrolysis produced by the method of claim 1.

12. A water electrolyzer comprising:
an anode formed by a an electrode comprising the catalyst of claim 11; and
a cathode.

13. The water electrolyzer of claim 12, wherein the cathode comprises an NiMoN catalyst (e.g., NiMoN) nanowire arrays supported on nickel (Ni) foam.

14. The water electrolyzer according to claim 12, wherein a voltage between the anode and the cathode of less than two volts provides a current density of at least 500 mA cm⁻², and optionally changes by less than 0.047 mV during the one-hundred hours of continuous water electrolysis.

15. The water electrolyzer according to claim 12, wherein the electrode is capable of delivering at least one of: a current density of 100 mA cm⁻² at an overpotential of less than or equal to 250 mV, a current density of 200 mA cm⁻² at an overpotential of less than or equal to 270 mV, or a current density of 500 mA cm⁻² at an overpotential of less than or equal to 300 mV.
